(19) United States
(12) Patent Application Publication
(10) Pub. No.: US 2024/0287739 A1
(43) Pub. Date: Aug. 29, 2024

(54) MICRO-OPTIC SECURITY DEVICE WITH ENHANCED WET-HARVEST RESISTANCE

(71) Applicant: Crane & Co., Inc., Dalton, MA (US)

(72) Inventors: Michael Darroch, Dalton, MA (US); Daniel Hassett, Pittsfield, MA (US)

(21) Appl. No.: 18/573,388

(22) PCT Filed: Aug. 5, 2022
(86) PCT No.: PCT/US2022/074636

§ 371 Date: Dec. 21, 2023

Related U.S. Application Data
(60) Provisional application No. 63/233,621, filed on Aug. 16, 2021.

(51) Int. Cl. D21F 1/44; B42D 25/324; B42D 25/333; B42D 25/351; B42D 25/355; B42D 25/425; D21H 21/42

(52) U.S. Cl. CPC D21F 1/44; B42D 25/324; B42D 25/333; B42D 25/355; B42D 25/425; D21H 21/42; B42D 25/351

(57) ABSTRACT

A method includes embossing a section of a micro-optic security thread at a predetermined pressure in an embossing die having a male half and a female half, the micro-optic security thread comprising a polymeric substrate having a first side and a second side, forming a web of a substrate in a paper making machine, wherein the web comprises a length of cellulosic material formed at a wet end of the paper making machine and maintained under tension between the wet end of the paper making machine and a dryer section of the paper making machine, forming a watermark feature in the substrate, and adhering the micro-optic security thread by positioning the embossed section such that the layer of icon elements contacts at least a portion of the web comprising the watermark feature.

### CROSS-REFERENCE TO RELATED APPLICATIONS

This application is a 371 National Stage of International Application No. PCT/US2022/074636, filed Aug. 5, 2022, which claims priority to U.S. Provisional Patent Application No. 63/233,621, filed Aug. 16, 2021, the disclosures of which are incorporated herein by reference.

### TECHNICAL FIELD

The present disclosure relates to enhancing the counterfeit resistance of secure documents, such as currency notes, passports and other documents comprising surface-applied micro-optic security devices. More specifically, this disclosure relates to a wet-harvest resistant embossed security device and methods for making same.

### BACKGROUND

Hardening passports, banknotes and other documents (referred to herein as “security documents”) whose constructional features include hard-to-reproduce indicia of the documents' authenticity against counterfeiting remains an ongoing source of technical challenges and opportunities for improvement in the field of security document design. “Harvesting,” whereby malicious actors break down an authentic security document in order to remove hard-to-reproduce components of the security document intact provides a mechanism by which malicious actors can obtain materials to produce counterfeit security documents. If removed substantially intact, hard-to-reproduce components of security documents, such as optical security devices (for example, security strips and patches) can, for example, be used to create up-cycled counterfeits (for example, by incorporating the security thread from a lower denomination banknote into a forgery of a higher denomination banknotes), or multiple counterfeits (for example, by using pieces of an embedded security thread from an authentic banknote to produce two counterfeit notes). While counterfeit security documents produced from harvested components can typically be identified by central banks and security document professionals, to the extent they provide visible indicia of authenticity which substantially matches those of authentic documents, such counterfeits are of serviceable quality to malicious actors in that they can readily pass for authentic security documents to everyday users.

As improvements in the printing and scanning technologies required to produce “good enough” or “street quality” facsimiles of the printed features on a paper substrate of a security continue to be commodified and made available to the general public, “wet harvesting” techniques, in which an original document is soaked in water or another solvent until a security thread, micro-optic device, or other non-printed security feature can be harvested for counterfeiting when it detaches from the substrate have become of particular concern.

### SUMMARY

The present disclosure illustrates embodiments of a wet-harvest resistant embossed security device and methods for making same.

In a first embodiment, a method for providing a wet harvest indicating security document includes embossing a section of a micro-optic security thread at a predetermined pressure in an embossing die having a male half and a female half, the micro-optic security thread comprising a polymeric substrate having a first side and a second side, wherein a layer of icon elements is disposed on the first side of the polymeric substrate, and a layer of micro-optic focusing elements is disposed on the second side of the polymeric substrate. The method further includes forming a web of a substrate in a paper making machine, wherein the web comprises a length of cellulosic material formed at a wet end of the paper making machine and maintained under tension between the wet end of the paper making machine and a dryer section of the paper making machine, forming a watermark feature in the substrate at the wet end of the paper making machine, adhering the micro-optic security thread by positioning the embossed section such that the layer of icon elements contacts at least a portion of the web comprising the watermark feature, and passing the portion of the web comprising the watermark feature and the adhered micro-optic security thread to the dryer section of the paper making machine.

In a second embodiment, a micro-optic security thread includes a polymeric substrate having a first side and a second side, an image icon layer contacting the first side of the polymeric substrate, a layer of focusing elements contacting the second side of the polymeric substrate, and an embossed portion comprising a region of the micro-optic security thread deflected along an axis perpendicular to the first side of the polymeric substrate.

In a third embodiment, a security document includes a cellulosic substrate comprising a watermark feature and a section of micro-optic security thread adhered to the cellulosic substrate. The micro-optic security thread includes a polymeric substrate having a first side and a second side, a layer of icon elements disposed on the first side of the polymeric substrate, a layer of micro-optic focusing elements disposed on the second side of the polymeric substrate, and an embossed portion deflected along an axis normal to the first side of the polymeric substrate relative to a surrounding portion of the micro-optic security thread, wherein the embossed portion of the micro-optic security thread covers a portion of the watermark feature.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of a mechanism by which security features of one authentic security document (in this example, a banknote) can be harvested and used to produce two counterfeit security documents of serviceable quality to malicious actors;

FIG. 2 illustrates an example of a security document according to certain embodiments of this disclosure;

FIG. 3 illustrates an example of an un-embossed section of an optical security device, which is incorporated in a security document, according to certain embodiments of this disclosure;

FIGS. 4A and 4B illustrate two examples of micro-optic security devices with enhanced harvesting resistance, according to various embodiments of this disclosure;

FIG. 5 illustrates an example of embossing a section of optical security device to enhance its wet harvest resistance, according to various embodiments of this disclosure;

FIG. 6 illustrates an example of how certain embodiments according to this disclosure provide enhanced resistance against wet harvesting;

FIGS. 7A-7C illustrate examples of tactile features formed in optical security devices by embossing according to various embodiments of this disclosure; and

FIG. 8 illustrates operations of an example method for making a security document with enhanced wet harvesting resistance according to various embodiments of this disclosure.

### DETAILED DESCRIPTION

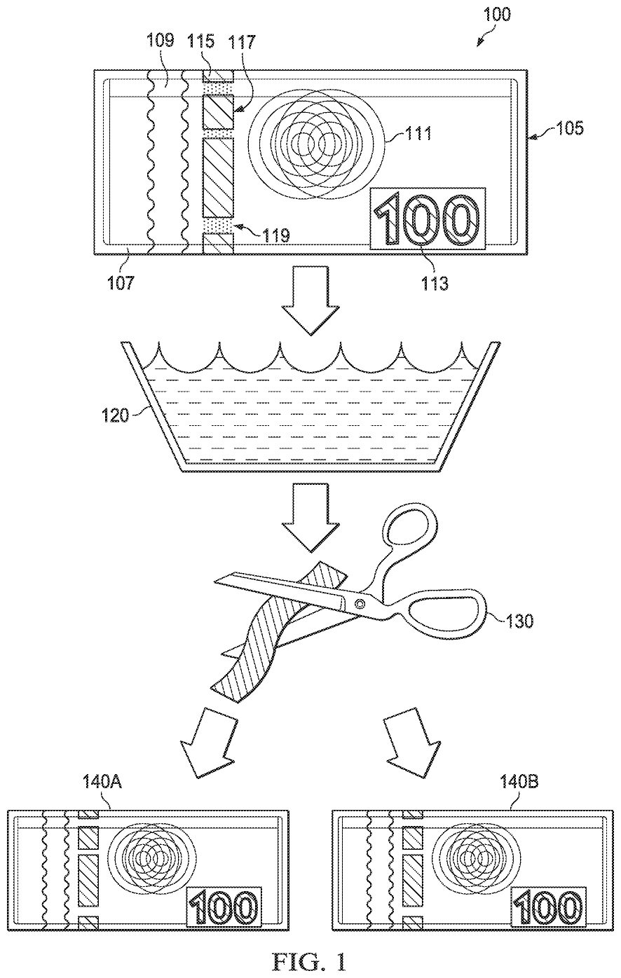

FIGS. 1 through 8, discussed below, and the various embodiments used to describe the principles of the present disclosure are by way of illustration only and should not be construed in any way to limit the scope of the disclosure. Those skilled in the art will understand that the principles of the present disclosure may be implemented in any suitably arranged security document.

Although the present disclosure has been described with various embodiments, various changes and modifications may be suggested to one skilled in the art. It is intended that the present disclosure encompass such changes and modifications as falling within the scope of the claims.

By way of background and exposition of at least one technical problem addressed by certain embodiments according to this disclosure, FIG. 1 illustrates an example 100 of a mechanism by which security features of one authentic security document 105 (in this example, a banknote) can be harvested and used to produce two counterfeit security documents of serviceable quality to malicious actors.

Referring to the example of FIG. 1, an example of a security document 105 is provided. As shown in the figure, security document 105 comprises a substrate 107 incorporating a plurality of constructional features which provide visible and invisible indicia of the authenticity of security document 105. Examples of constructional features which provide invisible indicia of the document's authenticity include, without limitation, magnetic inks or machine-readable features (for example, radio frequency identification (“RFID”)) antenna attached to, or embedded in, substrate 107.

Examples of constructional features which provide visible indicia of authenticity can also include watermarks, printed effects, specialty inks, and security devices formed in, applied to, or embedded in substrate 107. In this illustrative example, the constructional features of security document 105 which provide visible indicia of authenticity include a watermark 109. Further examples of constructional features of security document 105 which provide visual indicia of authenticity include intaglio design 111, which comprises a hard-to-reproduce pattern of lines, which due to the fine resolution of the pattern and use of intaglio printing techniques, produces a characteristic moiré interference effect, and has a distinctive surface texture. In this illustrative example, the constructional features of security document 105 which provide visual indicia of the document's authenticity include areas 113 printed with specialized, hard-to-obtain inks, such as optically variable inks or color shifting inks, whose appearance changes in response to changes in the angle of incidence of light hitting the ink. Constructional features which provide visible indicia of the authenticity of security document 105 can also include security devices 115. In some embodiments, security device 115 comprises a section of thin material (for example, a narrow ribbon of a polymer substrate) supporting one or more arrays of micro- or nano-scale optical structures, for example, lenses, icon structures, or diffraction gratings, which, collectively produce a distinctive optical effect. Examples of such optical effects include, without limitation, a moiré magnification effect (sometimes referred to as a “synthetically magnified image” or a “synthetic image”), a color shift, or a hologram.

Improvements in imaging and printing technology, as well as criminal resourcefulness, have provided malicious actors with the ability and materials to produce counterfeit security documents embodying serviceable facsimiles of many of the above-described constructional features which provide visible indicia of security documents' authenticity, with the principal exception being security devices 115. Given the tiny scale of the optical structures in security devices 115, and the institutional controls on certain of the tools, materials and technology involved in the production of security devices 115, most malicious actors do not presently have the means or technical know-how to produce counterfeits of security devices 115.

As a work-around to not being able to reproduce security device 115, malicious actors looking to produce counterfeit security documents “harvest” security devices from an authentic document to be incorporated into one or more counterfeit security documents. Referring to the explanatory example of FIG. 1, security device 115 is a micro-optic thread spanning the width of security document 100. In some cases, as shown in the figure, security device 115 is embedded into substrate 107 such that portions of security device 115 are visible through windows 117 in the substrate, and other portions of security device are concealed by bridges 119. In some cases, instead of embedding the security device 115 into the substrate 107 such that portions are visible through windows and some portions concealed by bridges, the security device 115 is applied or adhered to an exterior surface of the substrate 107, such as via a wet application of a thread including the security device 115 to the substrate 107 during a paper forming process and a subsequent drying process in which the security device 115 is cured to the exterior surface of the substrate 107.

Referring to the explanatory example of FIG. 1, malicious actors can, in certain cases, remove security device 115 substantially intact through prolonged soaking of security document 100 in a solvent (for example, water or bleach) to release the adhesive bond between security device 115 and substrate 107 or break down substrate 107. This process is referred to in the art as “wet harvesting.” Once removed substantially intact, security device 115 can be carefully cut 130 into pieces which can be affixed to the surface of a plurality of counterfeit substrates 140a and 140b, or alternatively, to the surface of an embedded carrier thread to create, from an initial number of authentic security documents, a larger number of counterfeit documents, which, though not perfect copies of security document 105, carry sufficient visual indicia of authenticity to be easily circulated and mistaken for authentic documents by many users.

While not discussed in the explanatory example of FIG. 1, other methods of producing counterfeit security documents can be enabled by harvesting security device 115 substantially intact. For example, once harvested, security device 115 may be up cycled to produce a counterfeit banknote of a higher denomination than security document 105, or in some cases, multiple counterfeit banknotes of the same denomination. Alternatively, in cases where a security document is an identification document, or otherwise associated with an authorized actor, harvesting security device 115 substantially intact can facilitate the creation of a counterfeit security document associated with an unauthorized actor (for example, to create a fake passport).

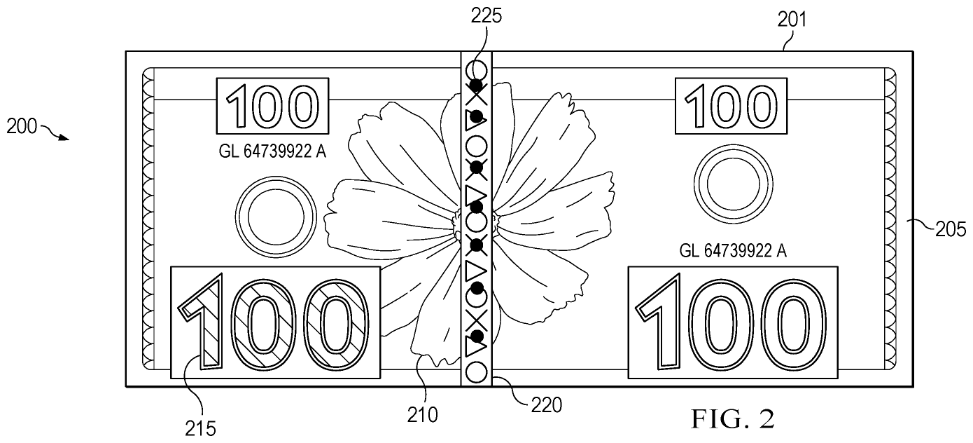

FIG. 2 illustrates an example of a security document according to certain embodiments of this disclosure.

As discussed with respect to the explanatory example of FIG. 1, one of the operative premises behind harvesting security devices from authentic security documents is that the security device can not only be separated from the substrate of the authentic document but separated in a substantially intact condition suitable for reuse in a counterfeit document. Where possible, counterfeiters also seek to preserve the substrate from which the security device is harvested.

Advantageously, and as discussed further herein, certain embodiments according to this disclosure undermine these operative premises by strategically altering or modifying an applied security feature and applying it to a security document in a way that maximizes the likelihoods that: a.) the security feature cannot be harvested intact; and b.) that the substrate will likewise be damaged and rendered unusable for use as a component of a counterfeit security document.

Referring to the non-limiting example of FIG. 2, an example of a security document 200 according to various embodiments of this disclosure is shown. According to some embodiments, security document 200 comprises a substrate 205, which comprises a first surface and a second surface. In some embodiments (for example, embodiments without window and bridge regions in substrate) the first surface comprises an outermost surface of substrate 205. In certain embodiments with window and/or bridge regions in substrate 205, the window and/or bridge regions are formed on the first surface.

According to various embodiments, first surface 201 comprises a cellulosic material. In certain embodiments, the cellulosic material of first surface 201 is a cellulosic material used to form the entirety of substrate 205. For example, substrate 205 may be made of paper formed on a Fourdrinier machine, and the cellulosic material on first surface 201 is derived from the pulp or fibrous slurry used to make the body of the substrate. In some embodiments, the first surface 201 comprises a cellulosic outer layer of a multi-layer substrate structure. According to various embodiments, the cellulosic material is, without limitation, one or more of wood pulp, cotton fiber, linen fiber, flax fiber, sisal fiber, hemp fiber, Abaca fiber, Kozo fiber, Mitsumata fiber, bamboo fiber or Kenaf fiber.

As shown in the non-limiting example of FIG. 2, the constructional features of security document 200 include one or more elements which provide visual indicia of the authenticity of security document. In this illustrative example, elements providing visual indicia of authenticity include, without limitation, watermark or watermarked area 210, areas 215 printed with optically variable ink (OVI) (for example, areas 113 in FIG. 1), and optical security device 220 (for example, security device 115 in FIG. 1).

Referring to the non-limiting example of FIG. 2, optical security device 220 is a thin, continuous strip which comprises micro-scale structures which project a synthetic image, providing optical indicia of the authenticity of security document 200. In this illustrative example, optical security device 220 is affixed to substrate 205. In certain embodiments, optical security device 220 comprises a third surface, comprising a thermoplastic polymer. Examples of suitable thermoplastic polymers include, without limitation, polyester, polypropylene and polyethylene terephthalate (“PET”).

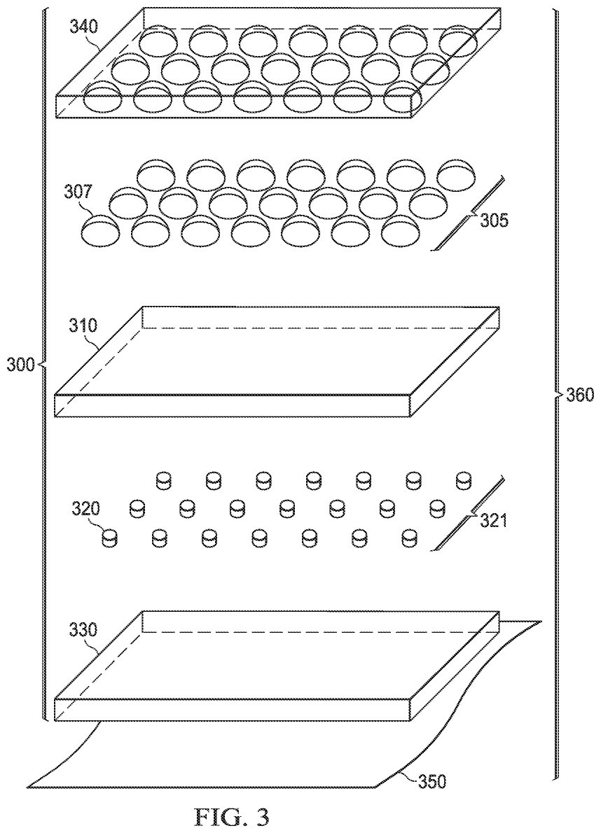

In some embodiments, the third surface of optical security device 220 is a seal layer of a micro-optic security device. In various embodiments, (for example, micro-optic systems which do not have a seal layer), the third surface is a layer of focusing elements. In some embodiments, the third surface is an image icon layer. In one or more embodiments, the third surface is a substrate of the optical security device 220 (for example, second substrate 330 in FIG. 3). According to various embodiments, optical security device 220 is affixed to substrate 205 as part of a roll-to-roll papermaking process used to form substrate 205 from a fibrous slurry. In certain embodiments, at least one side of optical security device 220 is bonded to an exterior surface of substrate 205 with an adhesive.

Surprisingly and advantageously, the inventors of the present disclosure have discovered that the harvesting resistance of certain optical security devices (for example, micro-optic threads) suitable for use in security documents can be significantly enhanced through periodically embossing the strip, and in some embodiments, affixing the security device to the substrate such that the embossed regions align with watermark features in the document substrate. As such, in certain embodiments according to this disclosure, embossed regions (for example, embossed region 225) of optical security device 220, when aligned with a watermarked region 210 of substrate 205 are reliably resistant to being harvested intact.

FIG. 3 illustrates an example of an un-embossed section of an optical security device 300, which is incorporated in a security document 360, according to certain embodiments of this disclosure.

Referring to the non-limiting example of FIG. 3, optical security device 300 comprises a plurality of focusing elements 305 (including, for example, focusing element 307), and an arrangement of image icons 320 (including, for example, image icon 321). According to various embodiments, each focusing element of plurality of focusing elements 305 has a footprint, in which one or more image icons of arrangement of image icons 320 is positioned. Collectively, the focusing elements of plurality of focusing elements 305, magnify portions of image icons 320 to produce a moiré magnification effect (also referred to as a “synthetically magnified image” or more briefly, a “synthetic image”) wherein the individually microscopic image icons are collectively magnified by the plurality of focusing elements 305 to produce an image which dynamically reacts (for example, by appearing to move, or change colors) in response to shifts in viewing angle. Given the small scale and tight manufacturing tolerances of the constituent structures of optical security device providing the moiré magnification effect, many malicious actors are not able to produce counterfeit versions of optical security device 300. Accordingly, optical security device 300 is, in many cases, a trusted visual indicium of a security document's (for example, security document 360) authenticity.

According to certain embodiments, plurality of focusing elements 305 comprises a planar array of micro-optic focusing elements. In some embodiments, the focusing elements of plurality of focusing elements 305 comprise micro-optic refractive focusing elements (for example, plano-convex or GRIN lenses). Refractive focusing elements of plurality of focusing elements 305 are, in some embodiments, produced from light cured resins with indices of refraction ranging from 1.35 to 1.7, and have diameters ranging from 5 μm to 200 μm. In various embodiments, the focusing elements of plurality of focusing elements 305 comprise reflective focusing elements (for example, very small concave mirrors), with diameters ranging from 5 μm to 50 μm. While in this illustrative example, the focusing elements of plurality of focusing elements 305 are shown as comprising circular plano-convex lenses, other refractive lens geometries, for example, lenticular lenses, are possible and within the contemplated scope of this disclosure.

As shown in the illustrative example of FIG. 3, arrangement of image icons 320 comprises a set of image icons (including image icon 321), positioned at predetermined locations within the footprints of the focusing elements of plurality of focusing elements 305. According to various embodiments, the individual image icons of arrangement of image icons 320 comprise regions of light cured material associated with the focal path of structured light (for example, collimated UV light) passing through plurality of focusing elements 305 from a projection point associated with one or more predetermined ranges of viewing angles. In some embodiments, the individual image icons of arrangement of image icons 320 are not provided within a structured image icon layer. As used in this disclosure, the term “structured image layer” encompasses a layer of material (for example, a light-curable resin) which has been embossed, or otherwise formed to comprise structures (for example, recesses, posts, grooves, or mesas) for positioning and retaining image icon material. According to various embodiments, the individual image icons of arrangement of image icons 320 are provided within a structured image layer, the structured image layer comprising one or more of voids, mesas, or posts, which act as retaining structures to hold micro- and nano-scale volumes of colored material.

As shown in the illustrative example of FIG. 3, in certain embodiments, optical security device 300 includes an optical spacer 310. According to various embodiments, optical spacer 310 comprises a film of substantially transparent material which operates to position image icons of arrangement of image icons 320 in or around the focal plane of focusing elements of plurality of focusing elements 305. In certain embodiments according to this disclosure, optical spacer 310 comprises a manufacturing substrate upon which one or more layers of light curable material can be applied, to form one or more of arrangement of image icons 320 or plurality of focusing elements 305.

According to various embodiments, optical security device 300 comprises one or more regions of light-cured protective material which occupy the spaces between the image icons of arrangement of image icons 320. In some embodiments, the arrangement of image icons 320 is first formed (for example, by selectively curing and removing liquid light-curable material on optical spacer 310), and then a layer of clear, light-curable material is applied to fill spaces between the image icons of arrangement of image icons 320 and then flood-cured to create a protective layer, which protects the image icons from being moved from their positions within the footprints of focusing elements of plurality of focusing elements 305. In certain embodiments, the light-curable material used to form arrangement of image icons 320 is a pigmented, ultraviolet (UV)-curable polymer.

In some embodiments, arrangement of image icons 320 is affixed to a second substrate 330, which operates to protect and secure arrangement of image icons 320 and provide an interface for attaching optical security device 300 to a substrate 350 (for example, substrate 205 in FIG. 2A) as part of security document 360. In some embodiments, optical security device 300 is affixed to substrate 350 during the manufacture of substrate in a paper-making machine, such as a Fourdrinier machine. According to some embodiments, optical security device 300 is affixed to substrate 350 by a layer of adhesive between the arrangement of image icons and a top surface of substrate 350.

In certain embodiments according to this disclosure, optical security device 300 comprises a seal layer 340. According to certain embodiments, seal layer 340 comprises a thin (for example, a 2 μm to 50 μm thick layer) of substantially clear material which interfaces on a lower surface, with focusing elements of the plurality of focusing elements 305 and comprises an upper surface with less variation in curvature (for example, by being smooth, or by having a surface whose local undulations are of a larger radius of curvature than the focusing elements) than the plurality of focusing elements 305. According to various embodiments, the upper surface of seal layer 340 is formed from a thermoplastic material which can be ultrasonically welded to a surface comprising a cellulosic material.

As shown in the non-limiting example of FIG. 3, in certain embodiments, optical security device 300 can be attached to substrate 350, to form a security document 360. According to various embodiments, substrate 350 comprises a sheet of material with at least one surface comprising cellulosic material, such as wood pulp, cotton fiber, linen fiber, flax fiber, sisal fiber, hemp fiber, Abaca fiber, Kozo fiber, Mitsumata fiber, bamboo fiber or Kenaf fiber. In some embodiments, substrate 350 is a blend of cotton and linen fibers, such as used for U.S. banknotes. For example, 350 may be made of a fiber blend which contains between 65-80% cotton fibers and between 20-35% linen fibers. In some embodiments, the relative proportions of cotton and linen fibers may be such that the substrate contains 65-100% cotton fibers and between 0 to 35% linen fibers.

While FIG. 3 provides one example of an optical security device 300 according to various embodiments, the present disclosure is not so limited. Other optical security devices which comprise at least one surface with a thermoplastic polymer and include hard-to-reproduce micro- and nano-scale optical structures (for example, holograms, devices providing thin-film effects, devices producing diffraction-based optical effects) which provide harvesting targets for malicious actors are within the contemplated scope of this disclosure.

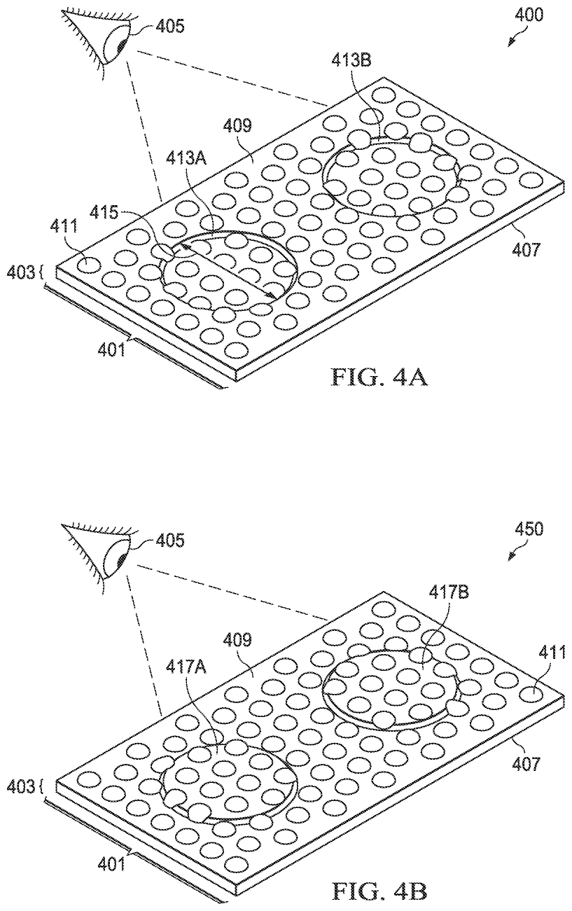

FIGS. 4A and 4B illustrate two examples of micro-optic security devices with enhanced harvesting resistance, according to various embodiments of this disclosure. For convenience of cross-reference, elements common to both of the illustrative examples of FIGS. 4A and 4B are numbered similarly.

While harvesting resistance is an important dimension to the performance of an optical security device as an indicia of authenticity (i.e., whatever its other merits, a security feature which can readily be transferred intact from an authentic document to one or more inauthentic documents is generally unfit for its intended purpose), it is not the only dimension of such a device's performance, but one of several, including performance of the micro-optic system, compatibility with existing manufacturing apparatus, and general preservation of the documents thickness and flexibility properties. In other words, achieving harvesting resistance at the cost of the ability to pass through and be read by a currency reader is of little, if any practical value.

FIG. 4A illustrates a view of an optical security device 400 with enhanced wet harvest resistance, according to various embodiments of this disclosure.

Referring to the illustrative example of FIG. 4A, optical security device 400 comprises a section of material (for example, optical security device 300 in FIG. 3) which, when viewed from a first direction 405, projects a synthetically magnified image of image icons of an image icon layer. According to various embodiments, optical security device 400 is a thread, or ribbon of material, having a width 401 and a thickness 403. In some embodiments, width 401 is between 5 mm to 10 mm. In various embodiments, width 401 is between 10 to 15 mm. In certain embodiments, thickness 403 is between 45-70 micrometers. In some embodiments, thickness 403 is less than 45 micrometers. In various embodiments, thickness 403 is greater than 70 micrometers. In various embodiments, sections of optical security device 400 are dispensed from a spool onto a forming substrate (for example, substrate 350 in FIG. 3) at a “wet end” of a papermaking machine (for example, before the web of paper is passed to the drying rolls).

As shown in the explanatory example of FIG. 4A, optical security device 400 comprises a first side 407 and a second side 409. First side 407 is, in this example, the side of optical security device 400 proximate to the arrangement of image icons. In embodiments in which optical security device 400 is surface mounted to a substrate, a layer of adhesive is applied either to the substrate, or to first side 407 to adhere optical security device 400 to a substrate. Second side is, in this example, the side of optical security device 400 facing a viewer. In this example, first side 409 is also proximate to the layer of refractive focusing elements (including micro-lens 411).

While, in the examples of FIGS. 4A and 4B, micro-optic security devices with enhanced harvesting resistance are described with reference to embodiments using refractive focusing elements, the present disclosure is not limited thereto. In embodiments using reflective focusing elements (for example, micro-mirrors), first surface 407 comprises the underside of the micro-optic security device (i.e., in surface-mounted applications, the side to which adhesive is applied and which faces the mounting substrate), and second surface 409 comprises the visible surface of the surface mounted optical device.

Surprisingly, the inventors have found that enhanced wet harvesting resistance can be achieved by creating embossed sections 413A and 413B in optical security device 400, wherein the embossed sections are formed by applying a suitable amount of pressure to a suitably proportioned male/female die pair acting on first side 407 and second side 409 of optical security device 400. Further, while creating embossed sections in optical security device 400 as described herein presents clear gains in harvesting resistance, there is no cost along other dimensions of system performance, such as device thickness or the ability of optical security device 400 to project a synthetic image.

According to certain embodiments, pressing an optical security device between the male and female half of an embossing die creates an embossed section which is, in this case, depressed relative to the surface of the surrounding un-embossed regions of micro-optic security device 400. Put differently, in the example of FIG. 4A, second side 409 in embossed region 413A is “pushed down” towards first side 407. In certain embodiments, in embossed region 413A, second side 409 is depressed between 0.004 and 0.011 inches relative to surrounding portions of second side 409. In some embodiments, embossed section 413A has a width (or longest dimension) between 3 and 5 millimeters. In some embodiments, embossed section 413A has a width between 5 and 8 millimeters.

While, in this illustrative example, embossed section 413A is shown as being circular in shape, embodiments according to this disclosure are not so limited. Experiments with star-shaped, number-shaped, bar-shaped, hexagonal, and text dies (for example, an embossing die with letters spelling “VOID”) have shown that fully operable optical security devices which become unusable in response to wet harvesting can be produced with a variety of die shapes.

FIG. 4B illustrates a second example of an optical security device 450 with enhanced wet harvesting resistance, according to certain embodiments of this disclosure. Referring to the non-limiting example of FIG. 4B, many of the constructional details of optical security device 450, such as the location of focusing elements relative to first side 407 and second side 409 are the same as with optical security device 400 in FIG. 4A. However, in this example, in embossed sections 417A and 417B, second side 409 is raised relative to the surrounding, un-embossed portions of second side 409. Testing has shown that, both downward embossing (such as illustrated in FIG. 4A) and upward embossing, such as shown in FIG. 4A, can enhance the wet harvest resistance of an optical security device, although in some cases downward embossing has been shown to be more effective. According to certain embodiments, second side 409 of embossed section 417A is raised between 0.004 and 0.011 inches relative to surrounding, un-embossed areas of second side 409.

While FIGS. 4A and 4B describe examples in which an optical security device has been embossed in a single direction relative to a surface (for example, second side 409) of the device, embodiments according to this disclosure are not so limited, and are intended to encompass embodiments in which an optical security device comprises embossed sections which are raised relative to a surrounding surface, as well as other embossed sections, which are depressed relative to the surrounding surface.

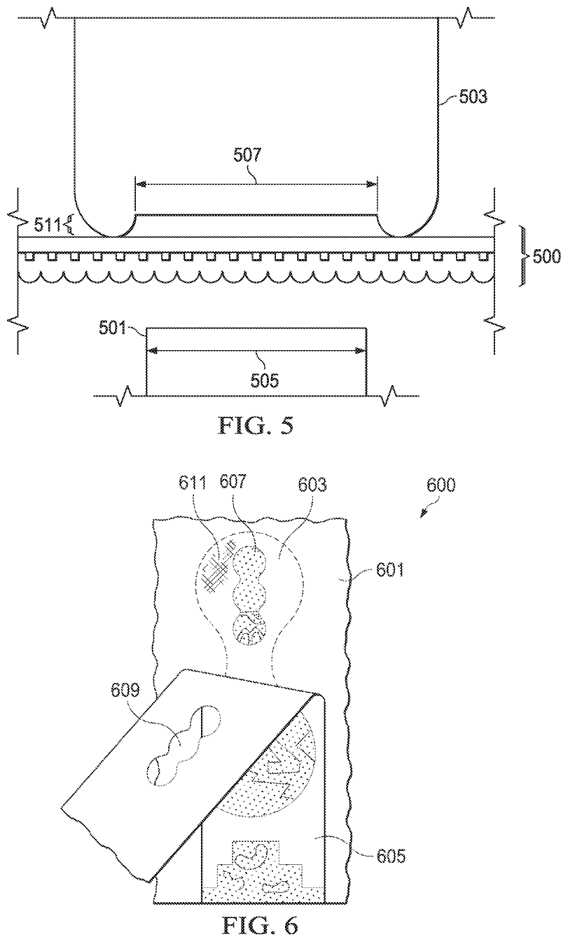

FIG. 5 illustrates an example of embossing a section of optical security device 500 (for example, optical security device 300 in FIG. 3) to enhance its wet harvest resistance, according to various embodiments of this disclosure.

Referring to the non-limiting example of FIG. 5, an un-embossed section of an optical security device 500 is shown positioned between the male half 501 and the female half 503 of an embossing die. As shown in the figure, the male half 501 of the embossing die comprises a protruding form having width 505. Female half 503 comprises a second section of material (for example, tool steel) with a void having a width 507 and a die depth 511. According to certain embodiments, width 507 is slightly larger than width 505 of the male half (thereby allowing male half 501 and female half 503 to apply pressure to optical security device 500, without slicing through it. Further, in certain embodiments, die depth 511 provides an upper limit to the extent to which a surface of an embossed section of optical security device 500 can be raised or depressed relative to the surrounding, un-embossed surface of optical security device 500.

To create embossed sections (for example, embossed section 413A in FIG. 4), the side of optical security device 500, which upon embossing, will have an embossed depression, faces male half 501, and a compressive force is applied to one or both halves of the embossing die, forcing a region of optical security device into the void of female half 503. Table 1, below, provides an example listing of die and pressure configurations which have been found to reliably impart wet harvest resistance to optical security device 500.

TABLE 1

| | | | Surface against |
|---|---|---|---|
| Sample | Die Depth, inches | Ram Pressure, lbs. | Male Die |
| 1 | 0.010 | 900 | Lens |
| 2 | 0.010 | 600 | Lens |
| 3 | 0.005 | 600 | Adhesive |
| 4 | 0.005 | 600 | Lens |

It will be understood that, although Table 1 lists varying amount of ram pressure, the actual amount of pressure applied to the optical security device can differ when applying the same amount of ram pressure depending on the type of die used.

As will be described in detail with reference to the example of FIG. 6 of this disclosure, wet harvest resistance can be achieved through either: a.) preventing the optical security device from being harvested intact; b.) preventing the substrate from being harvested intact; or c.) preventing both the substrate and optical security device from being harvested intact. The above-described combinations of die depths and die pressures achieve one or more of the above-listed modes of preventing wet harvesting.

FIG. 6 illustrates an example of how certain embodiments according to this disclosure provide enhanced resistance against wet harvesting.

Referring to the illustrative example of FIG. 6, a section of a security document 600 (for example, security document 200 in FIG. 2) is shown in the figure. Security document 600 comprises a cellulosic substrate 601 (for example, a section of linen/cotton blend currency paper), in which a watermark feature 603 has been formed. In this example, watermark feature 603 comprises a light area (i.e., an area of lower fiber density relative to unwatermarked portions of cellulosic substrate 601).

An optical security device 605 (for example, optical security device 400 in FIG. 4A) was affixed to cellulosic substrate 601. In this illustrative example, security document 600 was soaked in water until the adhesive bond between optical security device 605 and substrate 601 was weakened to the point where un-embossed sections of optical security device 605 could be peeled from substrate 601.

In some embodiments, optical security device 605 was affixed to cellulosic substrate 601 at the wet end of a paper machine used to create cellulosic substrate 601. As shown in the figure, optical security device 605 comprises an embossed region 607, which post-harvesting, separated from the remainder of optical security device, leaving hole 609 in optical security device 605. In this way, harvested optical security device 605 is unusable for reuse in a counterfeit document. Further, by aligning embossed region 607 with watermarked region 603, attempting to harvest optical security device 605 also creates visible damage 611 to substrate 601 in the area proximate to watermark 603. As shown in FIG. 6, post-harvesting, cellulosic substrate 601 is likewise rendered unfit for reuse in a counterfeit document, due to embossed section 607 remaining adhered, and visible damage 611.

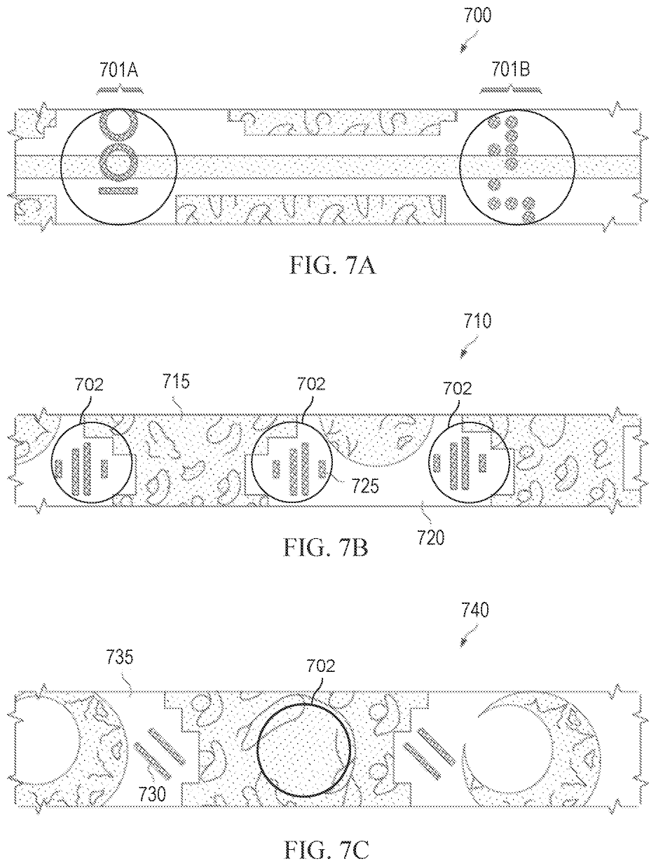

FIGS. 7A-7C illustrate examples of tactile features formed in optical security devices by embossing according to various embodiments of this disclosure.

Referring to the non-limiting example of FIG. 7A, an illustration of a section of an optical security device 700 (for example, optical security device 300 in FIG. 3) is provided in the figure. In this non-limiting example, two areas (701a and 701b) of optical security device 700 comprising tactile portions of the surface of optical security device 700 formed according to certain embodiments of this disclosure are depicted in the figure.

Referring to the illustrative example of FIG. 7A, by pressing a section of optical security device 700 between a male half and a female half of an embossing die, one or more embossed sections 702 are created. In some embodiments, the embossing process can occur prior to a roll-to-roll papermaking process, during which the embossed optical security device 700 is adhered to the substrate. In some embodiments, the embossing can occur as an in-line embossing operation during a paper making process, such as having a wheel converted to an embossing setup on a thread carriage just before a thread including optical security device 700 is applied to the substrate stock on a wire. In some embodiments, the optical security device 700 can be applied as a thread onto the substrate during paper production and then embossed using the embossing die post-paper production, enabling embossing to occur off the paper making machine, such as by using a stamping roll during sheeting, or in a print plant.

In various embodiments, embossing the optical security device 700 creates patterns based on the shape of the embossing die. These patterns can provide tactile indicia of the identity (for example, a denomination of a currency note) or authenticity of a security document. For example, portions of the embossing die can include one or more patterned elevated portions that, when pressed into the optical security device 700, create matching patterns on the optical security device 700. In some embodiments, upward embossing can be performed to create raised embossed regions on the optical security device 700, such as shown in FIG. 4B, including both anti-harvesting resistance features as described in the various embodiments of this disclosure and tactile indicia. In some embodiments, downward embossing can be performed, such as shown in FIG. 4A, resulting in either impressions within the depressed embossed section matching the embossing die patterns. In some embodiments, embossed regions can be created in a first embossing step to apply anti-harvesting features to the optical security device 700, followed by a second embossing step, such as using a differently shaped embossing die, to create tactile features either within the anti-harvesting embossed regions, or outside the anti-harvesting embossed regions at other locations on the optical security device 700.

According to certain embodiments, and as shown in embossed area 701a, tactile features created during embossing of the embossed area 701a, which can include other anti-harvesting features, can comprise one or more alphanumeric characters, such as the number “100.” In some embodiments, and as shown in embossed area 701b, tactile features created during embossing are spaced and formed to provide distinct features which can be resolved by a user's touch, such as braille lettering.

FIG. 7B illustrates another example of tactile features provided on a surface of an optical security device 710 (for example, optical security device 300 in FIG. 3) during embossing to a cellulosic surface, according to various embodiments of this disclosure. According to certain embodiments, optical security device 710 comprises microstructures (for example, microlenses, diffraction gratings, or other similarly-scaled structures) which produce a signature optical effect. The visible surface of optical security device 710 comprises one or more effect regions (for example, effect region 715) and one or more transition regions (for example, transition region 720). According to various embodiments, effect region 715 comprises an area within optical security device 710 comprising microstructures (for example, array of focusing elements 305 in FIG. 3) which contribute to the provision of a signature optical effect. In certain embodiments according to this disclosure, transition region 720 comprises a section of optical security device 710 in which the microstructures are not provided, or alternatively, in a section of optical security device 710 in which microstructures are present, but project white space in the design of the optical security device. According to some embodiments, transition region 720 is composed of an optical spacer (for example, optical spacer 310 in FIG. 3). In certain embodiments, optical security device 710 is affixed to the cellulosic surface using an adhesive, such as an acrylate, a thermoplastic or thermoset adhesive.

According to various embodiments, embossed patterns can be formed in the transition region 720, creating tactile features (for example, tactile feature 725), in one or more shapes, including, without limitation, bars, dots, circles and patterns thereof. In the example illustrated in FIG. 7B, the tactile features 725 are included within embossed regions 702 using upward or downward embossing. In this example, portions of the embossing regions 702 overlap with effect regions 715, while other portions of the embossed regions 702 including the tactile features 725 overlap with transition regions 720. It will be understood that, in some embodiments, the tactile features 725 can also be at least partially formed over the effect regions 715, such as shown in FIG. 7A.

FIG. 7C provides a further illustrative example of a tactile feature 730, formed in a transition region 735 of an optical security device 740, according to some embodiments of this disclosure. In this example, tactile features 730 are created by embossing, outside of an embossed region 703 that includes anti-harvesting features, such as by using an embossing die in the shape of the patterns matching tactile features 730, either by performing downward embossing or upward embossing. Although the tactile features 730 are formed in a transition region in this example, it will be understood that, in some embodiments, the tactile features 735 can also be at least partially formed over the effect regions, such as shown in FIG. 7A.

In various embodiments, the while FIGS. 7A-7C illustrate examples of tactile patterns created by embossing, it will be understood that various other patterns can also be embossed on an optical security device. Additionally, the tactile features can be raised patterns relative to a viewing surface of an optical security device, or can be lowered relative to the viewing surface of the optical security device, such as dents or depressions in the surface of the optical security device.

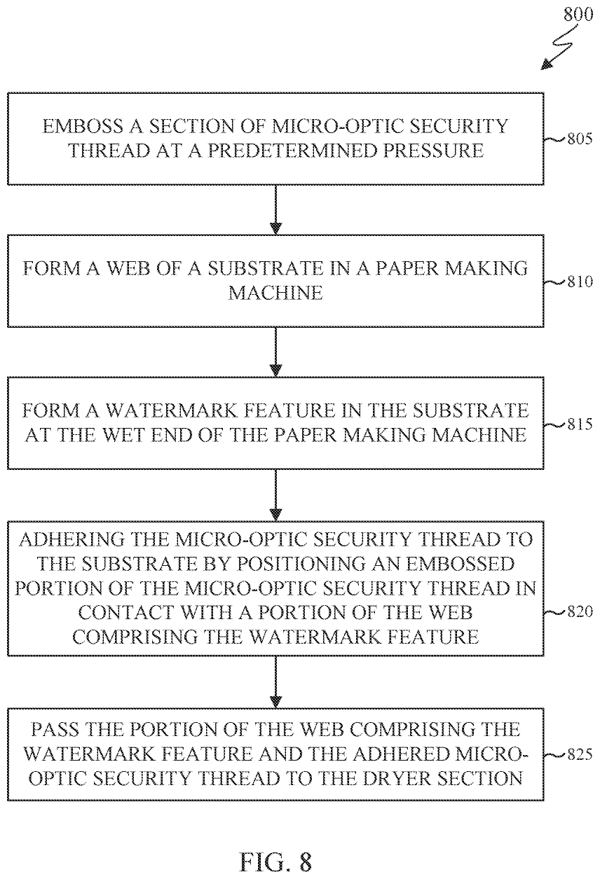

FIG. 8 illustrates operations of an example method 800 for making a security document with enhanced wet harvesting resistance according to various embodiments of this disclosure.

Referring to the illustrative example of FIG. 8, at operation 805, a section of micro-optic security thread (for example, optical security device 300 is embossed between the male and female half of an embossing die to create one or more embossed sections (for example, embossed section 413A in FIG. 4A).

At operation 810, a web of cellulosic substrate (for example, substrate 350 in FIG. 3 or cellulosic substrate 601 in FIG. 6) is formed in a paper making machine. In various embodiments, the web of substrate is formed in a Fourdrinier machine.

According to various embodiments, at operation 815, a watermark feature (for example, watermark feature 603 in FIG. 6) is formed in the cellulosic substrate. In some embodiments, the watermark feature is formed through application of a mesh fabric structure having contours defining the watermark feature. In various embodiments, the watermark feature is formed using an electrotype element. In some embodiments, the watermark feature is formed using a combination of the above-described methods.

At operation 820, the micro-optic security thread is adhered to the substrate. In some embodiments, the micro-optic security thread is affixed to the substrate using an adhesive which is activated by moisture in the web being formed by the papermaking machine. In various embodiments, the micro-optic security thread is affixed to the substrate such that an embossed portion (for example, embossed portion 607 in FIG. 6) is in contact with a watermark feature (for example, watermark feature 603 in FIG. 6) of the substrate.

At operation 825, the portion of the web comprising the watermark feature and the affixed micro-optic security thread is passed through the paper making machine to a dryer section of the machine. Depending on the adhesive used to affix the micro-optic security thread, the adhesive may be cured by the heat of the dryer section during operation 825.

While FIG. 8 provides an example of a method 800 for making a security document with enhanced wet harvesting resistance, various changes can be made to FIG. 8. For example, in some embodiments, the embossing process in operation 805 can occur prior to a roll-to-roll papermaking process, during which the embossed optical security device is adhered to the substrate. In some embodiments, the embossing operation 805 can occur after operation 815, such as an in-line embossing operation during a paper making process, such as having a wheel converted to an embossing setup on a thread carriage just before a thread including optical security device is applied or adhered to the substrate stock. In some embodiments, embossing operation 805 can occur after operation 825. For example, the optical security device can be applied as a thread onto the substrate during paper production and then embossed using the embossing die post-paper production, enabling embossing to occur off the paper making machine, such as by using a stamping roll during sheeting, or in a print plant.

Examples of methods for providing a wet harvest indicating security document according to this disclosure include embossing a section of a micro-optic security thread at a predetermined pressure in an embossing die having a male half and a female half, the micro-optic security thread comprising a polymeric substrate having a first side and a second side, wherein a layer of icon elements is disposed on the first side of the polymeric substrate, and a layer of micro-optic focusing elements is disposed on the second side of the polymeric substrate, forming a web of a substrate in a paper making machine, wherein the web comprises a length of cellulosic material formed at a wet end of the paper making machine and maintained under tension between the wet end of the paper making machine and a dryer section of the paper making machine, forming a watermark feature in the substrate at the wet end of the paper making machine, adhering the micro-optic security thread by positioning the embossed section such that the layer of icon elements contacts at least a portion of the web comprising the watermark feature and passing the portion of the web comprising the watermark feature and the adhered micro-optic security thread to the dryer section of the paper making machine.

Examples of methods for providing a wet harvest indicating security document according to this disclosure include methods wherein the embossing die has a depth between 0.004 and 0.011 inches.

Examples of methods for providing a wet harvest indicating security document according to this disclosure include methods wherein the embossed section of the micro-optic security thread is embossed by positioning the micro-optic security thread such that the male half of the embossing die contacts the layer of micro-optic focusing elements, and the female half of the embossing die contacts the layer of icon elements.

Examples of methods for providing a wet harvest indicating security document according to this disclosure include methods wherein the embossed section of micro-optic security thread is embossed by positioning the micro-optic security thread such that the female half of the embossing die contacts the layer of micro-optic focusing elements, and the male half of the embossing die contacts the layer of icon elements.

Examples of methods for providing a wet harvest indicating security document according to this disclosure include methods wherein the cellulosic material of the web comprises a blend of cotton and linen fibers.

Examples of methods for providing a wet harvest indicating security document according to this disclosure include methods wherein the cellulosic material comprises between 65-80% cotton fibers and between 20-35% linen fibers.

Examples of methods for providing a wet harvest indicating security document according to this disclosure include methods wherein the paper making machine is a Fourdrinier machine.

Examples of methods for providing a wet harvest indicating security document according to this disclosure include methods wherein the predetermined pressure is between 500 and 900 pounds of ram pressure upon the embossing die.

Examples of methods for providing a wet harvest indicating security document according to this disclosure include methods wherein embossing the section of the micro-optic security thread includes forming tactile indicia on the micro-optic security thread.

Examples of methods for providing a wet harvest indicating security document according to this disclosure include methods further comprising drying and calendering the portion of the web comprising the watermark feature and the adhered micro-optic security thread, soaking the portion of the web comprising the watermark feature and the adhered micro-optic security thread and wet harvesting the micro-optic security thread, wherein a part of the embossed section of the micro-optic security thread remains adhered to the watermark feature.

Examples of micro-optic security devices or threads according to this disclosure include micro-optic threads comprising a polymeric substrate having a first side and a second side, an image icon layer contacting the first side of the polymeric substrate, a layer of focusing elements contacting the second side of the polymeric substrate and an embossed portion comprising a region of the micro-optic security thread deflected along an axis perpendicular to the first side of the polymeric substrate.

Examples of micro-optic security devices according to this disclosure include micro-optic threads wherein the embossed portion is deflected such that the layer of focusing elements is depressed in the embossed portion relative to a surrounding portion of the micro-optic security thread.

Examples of micro-optic security devices according to this disclosure include micro-optic threads wherein the embossed portion is depressed between 0.004 and 0.011 inches relative to the surrounding portion of the micro-optic security thread.

Examples of micro-optic security devices according to this disclosure include micro-optic threads wherein the embossed portion is deflected such that the layer of focusing elements is raised in the embossed portion relative to a surrounding portion of the micro-optic security thread.

Examples of micro-optic security devices according to this disclosure include micro-optic threads wherein the embossed portion is raised such that the embossed portion is raised between 0.004 and 0.011 inches relative to the surrounding portion of the micro-optic security thread.

Examples of micro-optic security devices according to this disclosure include embossed tactile indicia.

Examples of security documents according to this disclosure include security documents comprising a cellulosic substrate comprising a watermark feature and a section of micro-optic security thread adhered to the cellulosic substrate by a layer of a moisture-activated adhesive, wherein the micro-optic security thread comprises a polymeric substrate having a first side and a second side, a layer of icon elements disposed on the first side of the polymeric substrate in contact with the layer of the moisture-activated adhesive, a layer of micro-optic focusing elements disposed on the second side of the polymeric substrate, and an embossed portion deflected along an axis normal to the first side of the polymeric substrate relative to a surrounding portion of the micro-optic security thread, wherein the embossed portion of the micro-optic security thread covers a portion of the watermark feature.

Examples of security documents according to this disclosure include security documents comprising a cellulosic substrate comprising a watermark feature and a section of micro-optic security thread adhered to the cellulosic substrate, wherein the micro-optic security thread comprises a polymeric substrate having a first side and a second side, a layer of icon elements disposed on the first side of the polymeric substrate, a layer of micro-optic focusing elements disposed on the second side of the polymeric substrate, and an embossed portion deflected along an axis normal to the first side of the polymeric substrate relative to a surrounding portion of the micro-optic security thread, wherein the embossed portion of the micro-optic security thread covers a portion of the watermark feature.

Examples of security documents according to this disclosure include security documents wherein the embossed portion of the micro-optic security thread is deflected between 0.004 and 0.011 inches along the axis normal to the first side of the polymeric substrate relative to the surrounding portion of the micro-optic security thread.

Examples of security documents according to this disclosure include security documents wherein the embossed portion of the micro-optic security thread is depressed relative to the surrounding portion of the micro-optic security thread.

Examples of security documents according to this disclosure include security documents wherein the embossed portion of the micro-optic security thread is raised relative to the surrounding portion of the micro-optic security thread.

Examples of security documents according to this disclosure include security documents wherein the cellulosic substrate comprises a blend of cotton and linen fibers.

Examples of security documents according to this disclosure include security documents wherein the cellulosic substrate comprises between 65-80% cotton fibers and between 20-35% linen fibers.

Examples of security documents according to this disclosure include security documents wherein the micro-optic security thread further comprises embossed tactile indicia.

Although the present disclosure has been described with various embodiments, various changes and modifications may be suggested to one skilled in the art. It is intended that the present disclosure encompass such changes and modifications as falling within the scope of the claims.

The present disclosure should not be read as implying that any particular element, step, or function is an essential element, step, or function that must be included in the scope of the claims. Moreover, the claims are not intended to invoke 35 U.S.C. § 112(f) unless the exact words “means for” are followed by a participle.

1. A method for providing a wet harvest indicating security document, the method comprising:
embossing a section of a micro-optic security thread at a predetermined pressure in an embossing die having a male half and a female half, the micro-optic security thread comprising a polymeric substrate having a first side and a second side, wherein a layer of icon elements is disposed on the first side of the polymeric substrate, and a layer of micro-optic focusing elements is disposed on the second side of the polymeric substrate;
forming a web of a substrate in a paper making machine, wherein the web comprises a length of cellulosic material formed at a wet end of the paper making machine and maintained under tension between the wet end of the paper making machine and a dryer section of the paper making machine;
forming a watermark feature in the substrate at the wet end of the paper making machine;
adhering the micro-optic security thread by positioning the embossed section such that the layer of icon elements contacts at least a portion of the web comprising the watermark feature; and
passing the portion of the web comprising the watermark feature and the adhered micro-optic security thread to the dryer section of the paper making machine.

2. The method of claim 1, wherein the embossing die has a depth between 0.004 and 0.011 inches.

3. The method of claim 1, wherein the embossed section of the micro-optic security thread is embossed by positioning the micro-optic security thread such that the male half of the embossing die contacts the layer of micro-optic focusing elements, and the female half of the embossing die contacts the layer of icon elements.

4. The method of claim 1, wherein the embossed section of micro-optic security thread is embossed by positioning the micro-optic security thread such that the female half of the embossing die contacts the layer of micro-optic focusing elements, and the male half of the embossing die contacts the layer of icon elements.

5. The method of claim 1, wherein the length of cellulosic material of the web comprises a blend of cotton and linen fibers.

6. The method of claim 1, wherein embossing the section of the micro-optic security thread includes forming tactile indicia on the micro-optic security thread.

7. The method of claim 1, further comprising:
drying and calendering the portion of the web comprising the watermark feature and the adhered micro-optic security thread;
soaking the portion of the web comprising the watermark feature and the adhered micro-optic security thread; and
wet harvesting the micro-optic security thread,
wherein a part of the embossed section of the micro-optic security thread remains adhered to the watermark feature.

8. A micro-optic security device comprising:
a polymeric substrate having a first side and a second side;
an image icon layer contacting the first side of the polymeric substrate;
a layer of focusing elements contacting the second side of the polymeric substrate; and
an embossed portion comprising a region of the micro-optic security device deflected along an axis perpendicular to the first side of the polymeric substrate.

9. The micro-optic security device of claim 8, wherein the embossed portion is deflected such that the layer of focusing elements is depressed in the embossed portion relative to a surrounding portion of the micro-optic security device.

10. The micro-optic security device of claim 9, wherein the embossed portion is depressed between 0.004 and 0.011 inches relative to the surrounding portion of the micro-optic security device.

11. The micro-optic security device of claim 8, wherein the embossed portion is deflected such that the layer of focusing elements is raised in the embossed portion relative to a surrounding portion of the micro-optic security device.

12. The micro-optic security device of claim 11, wherein the embossed portion is deflected such that the embossed portion is raised between 0.004 and 0.011 inches relative to the surrounding portion of the micro-optic security device.

13. The micro-optic security device of claim 8, further comprising embossed tactile indicia.

14. A security document comprising:
a cellulosic substrate comprising a watermark feature; and
a section of micro-optic security thread adhered to the cellulosic substrate,
wherein the micro-optic security thread comprises:
a polymeric substrate having a first side and a second side,
a layer of icon elements disposed on the first side of the polymeric substrate,
a layer of micro-optic focusing elements disposed on the second side of the polymeric substrate, and
an embossed portion deflected along an axis normal to the first side of the polymeric substrate relative to a surrounding portion of the micro-optic security thread,
wherein the embossed portion of the micro-optic security thread covers a portion of the watermark feature.

15. The security document of claim 14, wherein the embossed portion of the micro-optic security thread is depressed relative to the surrounding portion of the micro-optic security thread.

16. The security document of claim 15, wherein the embossed portion of the micro-optic security thread is depressed between 0.004 and 0.011 inches relative to the surrounding portion of the micro-optic security thread.

17. The security document of claim 14, wherein the embossed portion of the micro-optic security thread is raised relative to the surrounding portion of the micro-optic security thread.

18. The security document of claim 17, wherein the embossed portion of the micro-optic security thread is raised between 0.004 and 0.011 inches relative to the surrounding portion of the micro-optic security thread.

19. The security document of claim 14, wherein the cellulosic substrate comprises a blend of cotton and linen fibers.

20. The security document of claim 14, wherein the micro-optic security thread further comprises embossed tactile indicia.
